(19) United States
(12) Patent Application Publication
(10) Pub. No.: US 2017/0353800 A1
(43) Pub. Date: Dec. 7, 2017

(54) DIAPHRAGM ASSEMBLY

(71) Applicant: SLIVICE CO., LTD, Incheon (KR)

(72) Inventors: Han-Ryang LEE, Suwon-si (KR); Il-Kyung SUH, Incheon (KR)

(21) Appl. No.: 15/538,585

(22) PCT Filed: Jan. 15, 2016
(86) PCT No.: PCT/KR2016/000470

§ 371 Date: Jun. 21, 2017

(30) Foreign Application Priority Data
Jan. 17, 2015 (KR) 10-2015-0008376

(51) Int. Cl. H04R 7/20; H04R 9/02; H04R 7/26; H04R 9/06; H04R 7/12

(52) U.S. Cl. CPC H04R 7/20; H04R 9/06; H04R 7/12; H04R 7/26; H04R 9/025

(57) ABSTRACT

A diaphragm assembly according to the present invention comprises: a diaphragm for generating sound pressure by means of vibration; and an edge, which is made from an elastic material and has one side coupled to the diaphragm and has the other side coupled to a fixing end, wherein the diaphragm comprises: a diaphragm plane generating sound pressure by means of vibration, and having a rim; an extending part formed by extending outwards from at least a portion of the diaphragm plane; and a coupling part formed at the end of the extending part and coupled to the fixing end. One side of the edge is coupled to the rim of the diaphragm plane. The extending part and/or the coupling part is not formed at a long-axis portion.

### TECHNICAL FIELD

The present invention relates to a diaphragm assembly, and more particularly, to a diaphragm assembly capable of improving frequency characteristics including the damping function thereof.

### BACKGROUND ART

A component speaker includes a diaphragm assembly. When a driving force is applied to the diaphragm, the diaphragm assembly vibrates to generate a sound pressure. The driving force varies depending on the speaker type. The dynamic speaker uses electromagnetic force induced in the coil as the driving force. The electrostatic speaker uses electrostatic force acting on the diaphragm as the driving force. The piezoelectric speaker uses change of the shape of the piezoelectric body as the driving force.

FIG. 1 shows a conventional diaphragm assembly and a speaker apparatus including the same. A diaphragm assembly used for a TV or the like generally has a square or track shape with a major axis and a minor axis perpendicular to the major axis. This rectangular shape is advantageous in attaching the speaker to the bezel located at the edge of the display. The diaphragm assembly includes a vibration surface 60, an edge 50, and a suspension 40. The vibration surface 60 is formed of compressed pulp and includes a stiffness enhancing portion forming a convex portion on the upper surface thereof to enhance the stiffness.

The edge 50 is formed of an elastic material such as Thermoplastic Polyurethane (TPU) and has an annular shape so as to be joined to the rim of the vibration surface. The edge includes a portion formed on the inner side thereof and joined to the vibration surface and a portion formed on the outer side thereof and joined to a fixed end such as a frame of the speaker apparatus or the suspension 40. A convex portion for structurally enhancing the elasticity of the edge is formed between the joining portion of the vibration surface and the joining portion of the fixed end.

The suspension 40 functions to provide a damping force to the vibration surface 60 and is formed by a metal leaf spring. One side of the suspension 40 is attached to the bottom surface of the vibration surface 60 and the other side is attached to a fixed end such as the frame 20 of the speaker apparatus.

Since the speaker of a rectangular structure has a different vibration distance according to the direction of vibration, it structurally has a poor frequency response characteristic compared to speakers having a circular or square structure. Particularly, since the vibration surface 60 is elongated along the major axis, break-up vibration occurs by a vibration mode at a specific frequency. When the break-up mode vibration occurs, vibrations having a phase difference of 180° between a specific area and an adjacent area of the vibration surface 60 cause destructive interference with each other, and a dip phenomenon, which refers to significant drop of the sound pressure at a corresponding frequency, inevitably occurs. The dip phenomenon distorts the frequency response characteristic of the speaker apparatus, and as a result, the output sound is distorted, which results in severe degradation of sound quality.

The suspension 40 may provide an additional damping force to help attenuate the dip phenomenon caused by the break-up mode vibrations. However, the suspension 40 provides only limited damping, and is therefore not sufficient to eliminate the dip phenomenon. Moreover, since the conventional diaphragm structure further includes the suspension 40, the unit cost is increased, and the process becomes complicated. Thereby, the process cost is increased, and the defect rate is increased.

### DISCLOSURE

### Technical Problem

It is an aspect of the present invention to provide a diaphragm assembly capable of providing a damping force to a vibration surface and suppressing the break-up mode vibration.

It is another aspect of the present invention to provide a diaphragm assembly with a major axis and a minor axis capable of suppressing abnormal noise that may occur in the diaphragm assembly.

### Technical Solution

In accordance with one aspect of the present invention, a diaphragm assembly includes: a diaphragm configured to generate a sound pressure by vibration; and an edge of an elastic material, one side of the edge being joined to the diaphragm and the other side of the edge being joined to a fixed end, wherein the diaphragm includes: a vibration surface configured to generate a sound pressure by vibration and having a rim; an extension extending outward from at least a part of the vibration surface; and an joining portion formed at an end of the extension and joined to the fixed end, wherein the one side of the edge is joined to the rim of the vibration surface.

In the diaphragm assembly according to an embodiment of the present invention, the extension partially extends from the vibration surface.

In the diaphragm assembly according to an embodiment of the present invention, the joining portion is annularly connected to connect the plurality of the partially extending extensions. In the diaphragm assembly according to an embodiment of the present invention, the vibration surface is substantially formed in a rectangular shape having the major axis and the minor axis, and the extension includes a primary extension formed to extend from both ends of the major axis of the vibration surface.

In the diaphragm assembly according to an embodiment of the present invention, the vibration surface further includes a secondary extension adjacent to the primary extension.

In the diaphragm assembly according to an embodiment of the present invention, a surface of the secondary extension adjacent to the primary extension extends at an acute angle with respect to the vibration surface.

In the diaphragm assembly according to an embodiment of the present invention, a surface of the secondary extension adjacent to the primary extension extends at an obtuse angle with respect to the vibration surface.

In the diaphragm assembly according to an embodiment of the present invention, the extension extends curvedly.

In the diaphragm assembly according to an embodiment of the present invention, the extension includes a downwardly convex shape.

In the diaphragm assembly according to an embodiment of the present invention, the vibration surface has the same height as the joining portion.

In the diaphragm assembly according to an embodiment of the present invention, the extension includes an upwardly convex shape.

In the diaphragm assembly according to an embodiment of the present invention, a damping agent is applied to an upper surface of the extension.

In the diaphragm assembly according to an embodiment of the present invention, the joining portion is joined to a bottom surface of the edge through an upper surface thereof.

In the diaphragm assembly according to an embodiment of the present invention, the damping agent applied to the upper surface of the extension contacts the bottom surface of the edge.

In the diaphragm assembly according to an embodiment of the present invention, the joining portion is joined to a frame of a speaker apparatus through a bottom surface thereof.

In the diaphragm assembly according to an embodiment of the present invention, the joining portion is joined to a frame of a speaker apparatus with a metal suspension interposed.

In accordance with another aspect of the present invention, a diaphragm assembly including a diaphragm configured to generate a sound pressure by vibration, wherein the diaphragm includes: a vibration surface configured to generate a sound pressure by vibration and formed in a shape having a major axis and a minor axis, the vibration surface having a rim; an extension extending outward from at least a part of the rim near both ends of the major axis of the vibration surface and not formed on at least a part of the rim near the minor axis of the vibration surface; and an joining portion formed at an end of the extension and joined to the fixed end, wherein a part of the vibration surface on the major axis is not connected to the fixed end.

In the diaphragm assembly according to an embodiment of the present invention, at least one of the extension and the joining portion is not formed at the part on the major axis.

### Advantageous Effects

According to the configuration above, the diaphragm assembly according to the present invention may suppress the break-up mode vibrations by generating an additional damping force through an extension.

### DESCRIPTION OF DRAWINGS

FIG. 1 is an exploded perspective view of a speaker apparatus including a diaphragm assembly according to the prior art.

FIG. 2 is a perspective view of a speaker apparatus including a diaphragm assembly according to an embodiment of the present invention.

FIG. 3 is an exploded perspective view of a speaker apparatus including a diaphragm assembly according to an embodiment of the present invention.

FIGS. 4 to 15 are plan views of a diaphragm of a diaphragm assembly according to other embodiments of the present invention.

FIG. 16 is a cross-sectional view taken along line a-a in FIG. 15;

FIGS. 17 to 20 are a perspective view and a plan view of a diaphragm of a diaphragm assembly according to other embodiments of the present invention.

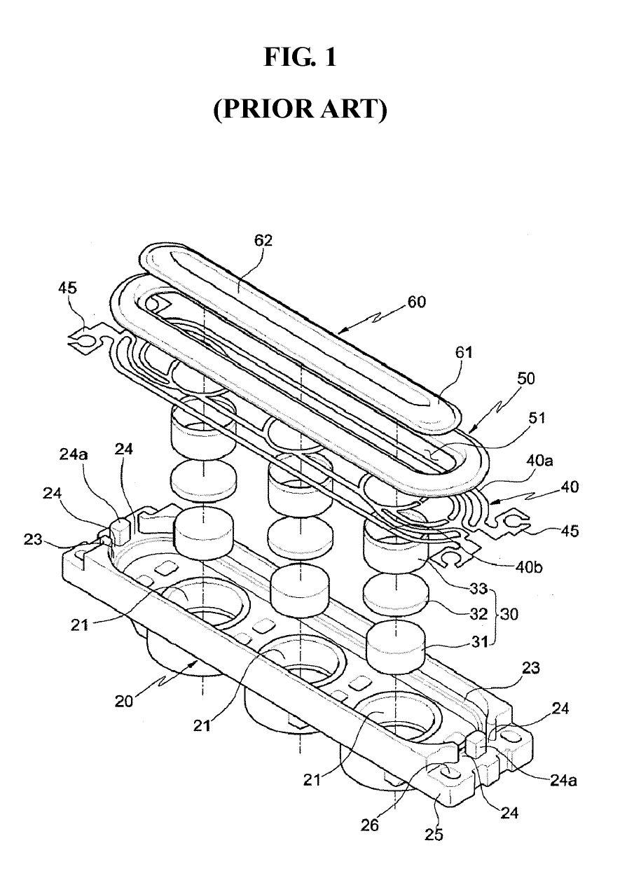

### BEST MODE

A diaphragm assembly according to the present invention includes a diaphragm and an edge.

The diaphragm 110 functions to generate a sound pressure by vibration. The material of the diaphragm 110 is not particularly limited, and materials such as, for example, paper, metal, polymer film, glass fiber, or carbon fiber may be used. The shape of the plane of the diaphragm 110 is not particularly limited and may be a plane shape such as a square, a circle, a rectangle, a track, an ellipse, or the like. The diaphragm 110 includes a vibration surface 112, an extension 114, and a joining portion 116.

The vibration surface 112 functions to generate a sound pressure by vibration, and the rim thereof is joined to the inner side of the edge 120. The extension 114 is formed to extend outward from at least a part of the vibration surface. The extension 114 is preferably formed on the outer side on the major axis to effectively eliminate the break-up mode vibration along the major axis. The joining portion 116 is formed at the end of the extension and joined to a fixed end such as a frame of the speaker apparatus or the outer side of a metal suspension. The vibration surface 112, the extension 114, and the joining portion 116 are integrally formed. Since the vibration surface 112, the extensions 114 and the joining portion 116 are integrally formed, the manufacturing cost of the diaphragm 110 may be reduced by producing the diaphragm 110 through a single press operation.

In the conventional diaphragm assembly 10, the entire rim of the diaphragm 11 is joined to the edge 12, and the diaphragm 11 is not directly connected to a fixed end such as a frame but connected to the fixed end through the edge 12. In the present invention, on the other hand, the diaphragm assembly is indirectly connected to the fixed end through the edge 120, and in addition, the joining portion 116 of the diaphragm 110 is directly connected to the fixed end. The fixed end may provide a damping force directly to the vibration surface 112 via the extension 114. With this configuration, the diaphragm 110 functions as a conventional suspension. According to this configuration, the diaphragm can provide a direct damping force to the vibration surface to eliminate the metal suspension, and therefore the manufacturing cost of the diaphragm assembly is reduced, and the step of attaching the suspension is eliminated. Thereby, the assembly cost is reduced, and the defect rate is lowered.

According to an embodiment, the diaphragm assembly may further include a conventional metal suspension 130. In this case, the damping force provided by the extension 114 of the diaphragm 110 and the additional damping force of the suspension 130 are provided, and thus the break-up mode vibration of the diaphragm 110 can be prevented more effectively. Thereby, vibration close to an ideal piston vibration in which the entire area of the vibration surface 112 uniformly vibrates may be obtained. More preferably, the height of the extension 114 may be less than the heights of the vibration surface 112 and the joining portion 116, and may have a downwardly curved shape. More specifically, the extension 114 may have a curved shape that is convex downward. This shape is advantageous in providing the additional damping force of the extension 114.

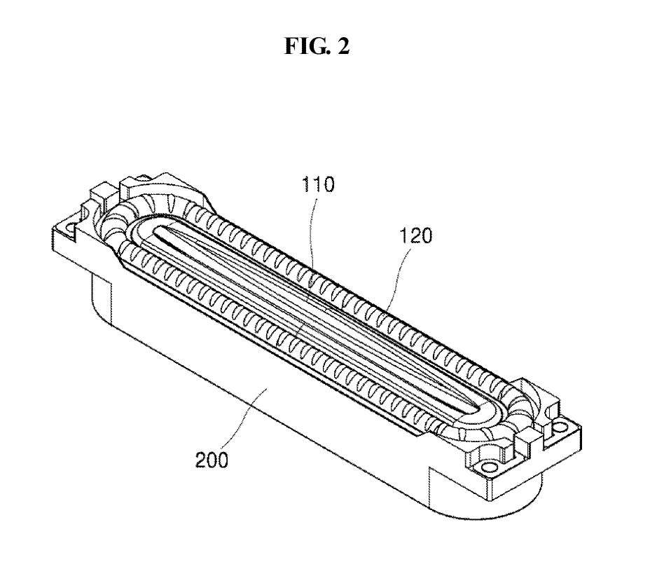

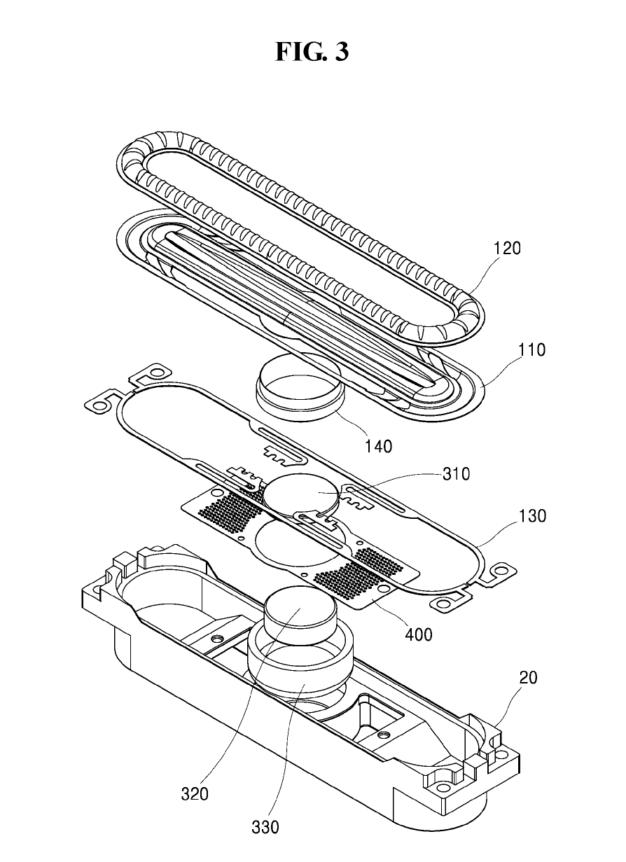

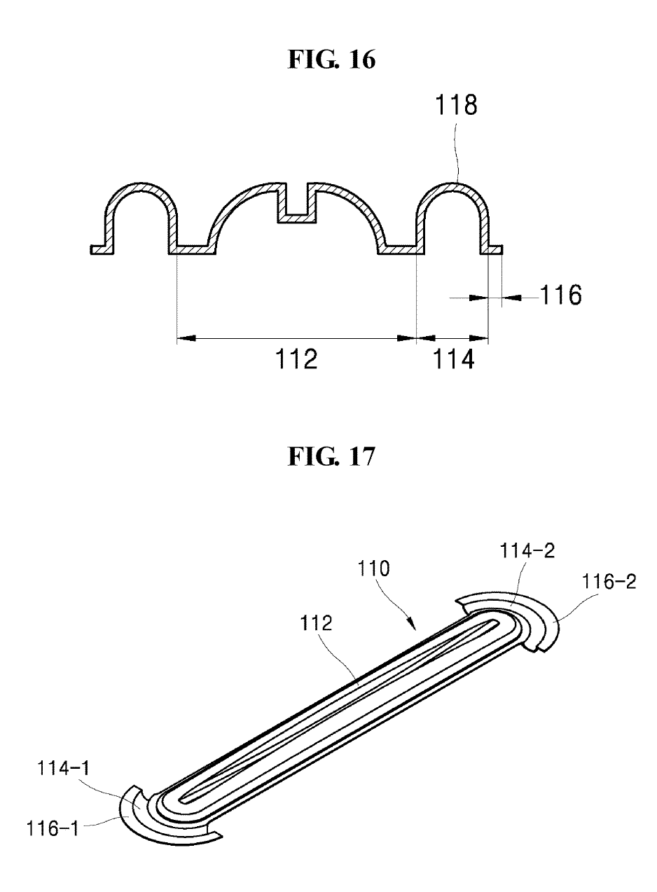

Alternatively, the extension 114 may have a curved shape that is convex upward (see FIGS. 15 and 16). In this case, the shape of the extension 114 and the cross-sectional shape of the edge 120 shown in FIGS. 2 and 3 may correspond to each other to some extent. According to this structure, a damping agent 118 may be applied to the upper surface of the extension 114 and covered by the edge 120. Thereby, the bottom surface of the edge 120 may appear to be covered with the damping agent 118. Particularly, in the case of a speaker having a diaphragm of a rectangular, track, or elliptic shape, which is the main application object of the present invention, there is a possibility that fine vibration occurs at both ends of the major axis of the diaphragm, generating noise and deteriorating sound quality. If the above structure is applied to the extension 114 extending outward from both ends of the major axis of the vibration surface 112, the fine vibration occurring at both ends of the major axis of the diaphragm may be easily eliminated without requiring any additional parts or processes.

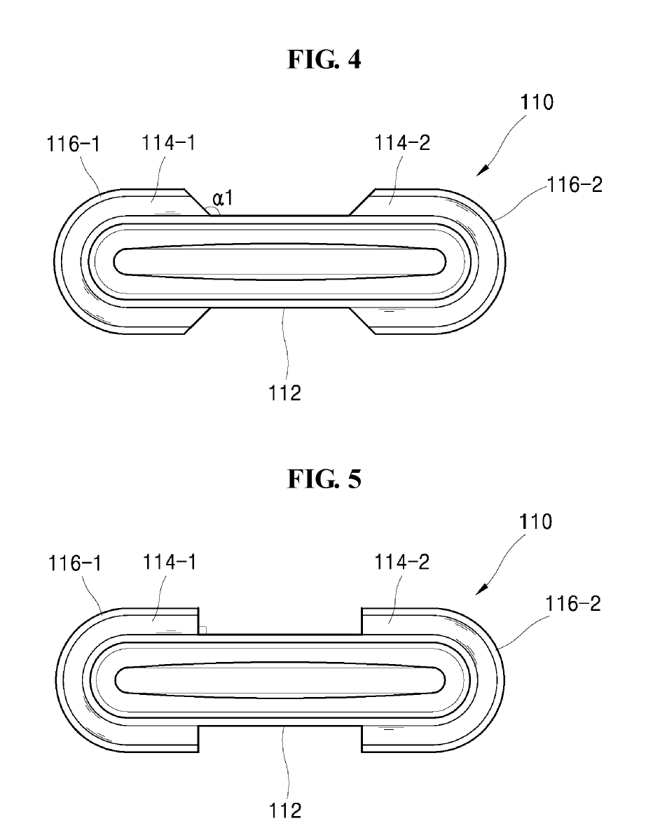

The shapes of the extension 114 and the joining portion may be diversified according to the material of the diaphragm or the sound characteristic of a desired speaker apparatus. According to the embodiment of FIG. 4, two extensions 114 extend on the outer sides of the major axis of the diaphragm, and the joining portion 116 is formed to extend from each of the extensions 114. Although the joining portion 116 is shown as being distinguished from the extensions 114 in the figure, it indicates the areas to be adhered to the fixed end, and may be integrated with each other in a practical product so as not to be visually distinguished.

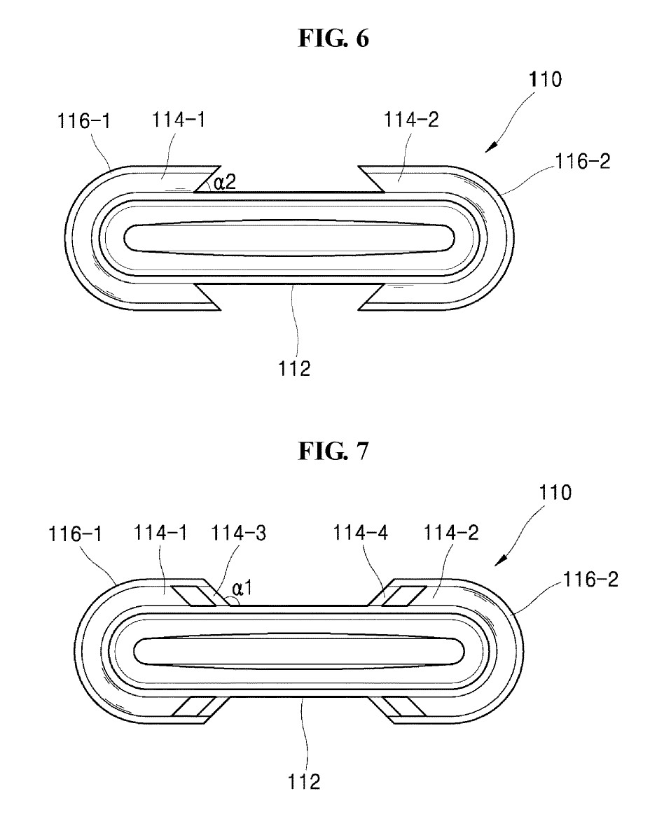

Here, the shape of the extension 114 may form an obtuse angle α1 with respect to the vibration surface 112 as shown in FIG. 4, form a right angle with respect to the vibration surface 112 as shown in FIG. 5, or form an acute angle α2 with respect to the vibration surface 112 as shown in FIG. 6. Although not shown, the joining portion 116 may be configured to be connected in a closed loop shape as in the embodiments of FIGS. 10 to 14. These various shapes may be selectively applied according to the material of the diaphragm and desired sound characteristics.

According to the embodiments shown in FIGS. 4 to 6, in the diaphragm 110, a weak damping force acts on the middle portion of the major axis, and a strong damping force acts on the ends of the major axis of the diaphragm. Therefore, the break-up mode vibration may be effectively prevented, and suppression of vibration of the vibration surface 112 may be minimized. Thereby, lowering of the SPL and increase of the resonance frequency may be minimized.

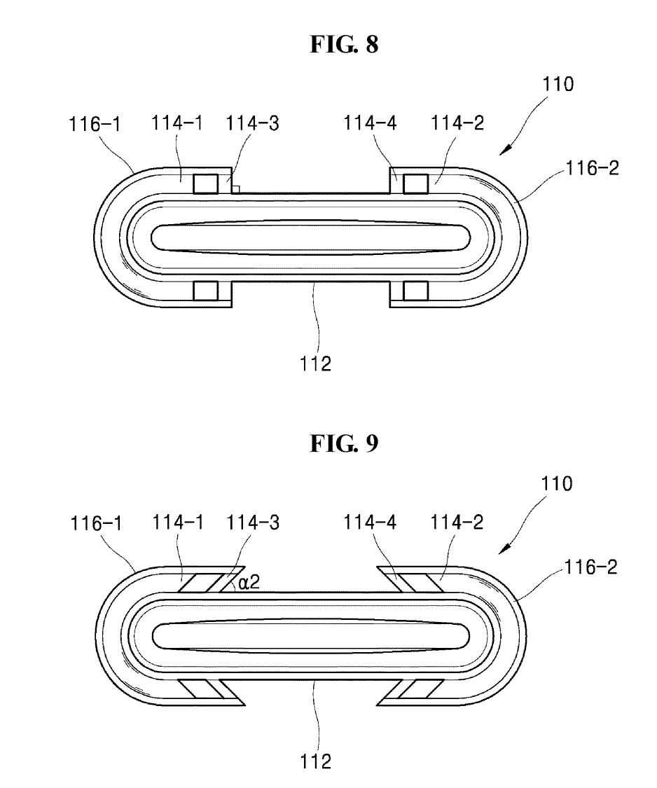

Hereinafter, the embodiments of FIGS. 7 to 9 will be described. These embodiments are different from the embodiments of FIGS. 4 to 6 in that the extension 114 further includes a primary extension 114-1, 114-2 and a secondary extension 114-3, 114-4 formed adjacent thereto. The end of the primary extension 114-1, 114-2 is connected to the end of the secondary extension 114-3, 114-4 adjacent to the primary extension 114-1, 114-2 through a joining portion 116-1, 116-2. Here, the shapes of the secondary extension 114-3, 114-4 may form an obtuse angle α1 with respect to the vibration surface 112 as shown in FIG. 7, a right angle with respect to the vibration surface 112 as shown in FIG. 8, or an acute angle α2 with respect to the vibration surface 112 as shown in FIG. 9. Four secondary extensions 114 are formed in a manner that one secondary extension 114 is formed at four each end of the two primary extensions 114. However, the number of the secondary extensions 114 is not limited thereto. 8 secondary extensions may be formed in a manner that two secondary extensions are formed at each end, or 12 or more secondary extensions may be formed in a manner that three or more secondary extensions are formed at each end.

According to the embodiments of FIGS. 7 to 9, the secondary extensions 114-3 and 114-4 can provide an additional damping force, and accordingly the break-up mode vibration of the diaphragm may be more effectively suppressed.

Hereinafter, the embodiments of FIGS. 10 to 14 will be described. These embodiments are different from the embodiments of FIGS. 7 to 9 in that the joining portion 116 is connected in a ring shape. According to these embodiments, since the joining portion 116 is seamlessly connected to the fixed end, a stronger damping force can be provided to the vibration surface 112.

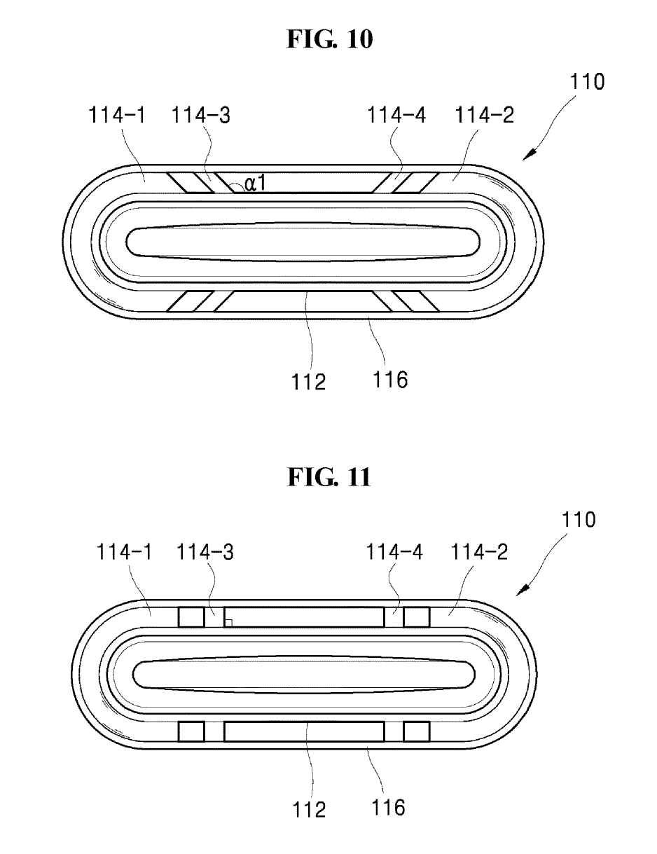

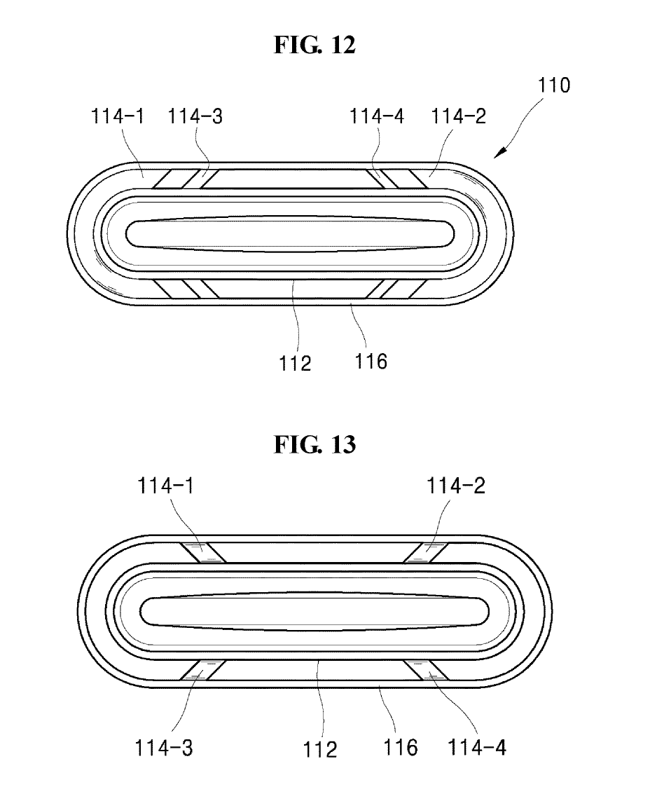

The shape of the secondary extensions 114-3 and 114-4 may form an obtuse angle α1 with respect to the vibration surface 112 as shown in FIG. 10, a right angle α1 with respect to the vibration surface 112 as shown in FIG. 11, or an acute angle α2 with respect to the vibration surface 112 as shown in FIG. 12. Four secondary extensions 114-3, 114-4 are formed in a manner that one secondary extension 114-3, 114-4 is formed at each of both ends of the primary extensions 114-1, 114-2. However, the number of the secondary extensions is not limited thereto. 8 secondary extensions may be formed in a manner that two secondary extensions are formed at each end, or 12 or more secondary extensions may be formed in a manner that three or more secondary extensions are formed at each end.

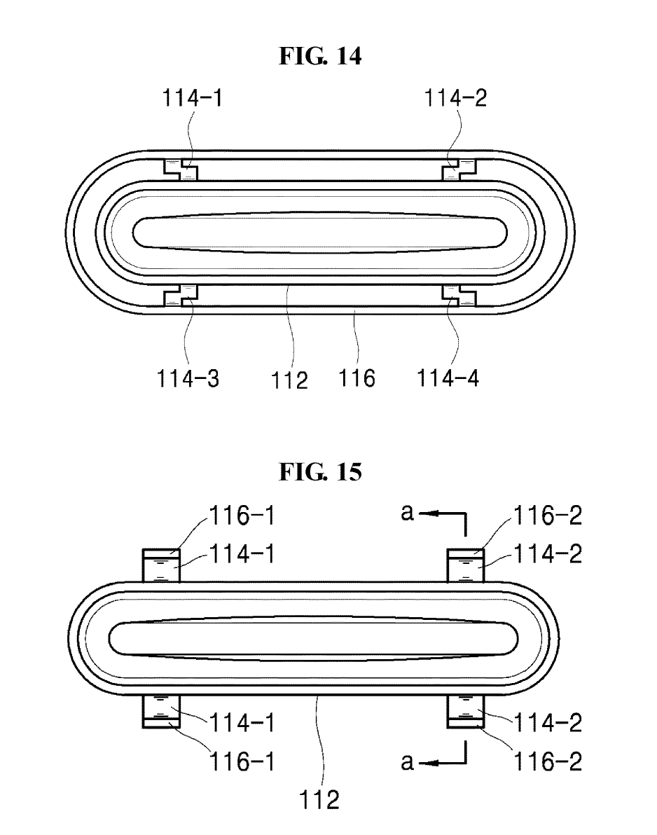

FIG. 13 illustrates an embodiment in which four extensions 114-1, 114-2, 114-3, and 114-4 extend outward from the edges near both ends of the diaphragm on the major axis and the joining portion 116 is connected in a ring shape. FIG. 14 illustrates an embodiment similar to the embodiment of FIG. 13. In the embodiment of FIG. 14, the extensions 114-1, 114-2, 114-3, and 114-4 have a refracting shape to provide an additional damping force. Such a refracting shape is not limited to the embodiment shown in FIG. 14. The shape may have a single refraction, two refractions as shown in the figure, or three or more refractions.

FIGS. 15 and 16 illustrate an embodiment in which four extensions 114-1, 114-2, 114-3, and 114-4 extend outward from the edges near both ends of the diaphragm on the major axis and the joining portion 116 is not connected in a ring shape. The ends of the four extensions are provided with joining portions 116-1, 116-2, 116-3, and 116-4, respectively. The extensions shown in FIGS. 15 and 16 have an upwardly convex shape, which correspond to the convex shape of the edge 120 shown in FIGS. 2 and 3. The damping agent 118 is applied to the upper portions of the extensions 120. In the process of joining one side of the edge 120 to the rim of the vibration surface, the extensions are accommodated in a space formed in the bottom surface of the edge 120, and the damping agent 118 applied to the upper portions of the extensions is brought into contact and covered with the inner surface of the edge 120. Thus, the structure of the extensions of FIGS. 15 and 16 may not only further provide a damping force to the vibration surface through the extensions, but also eliminate fine vibration generated at both ends of the vibration surface on the major axis, through the damping agent 118 and the edge 120.

While FIG. 15 illustrates that the extensions 114 form a right angle with respect to the vibration surface 112, the extensions 114 may form an obtuse angle α1 or an acute angle α2 with respect to the vibration surface 112, as shown in the other embodiments and figures described above. Needless to say, it is also possible for the extensions to have a refracting shape as shown in FIG. 14. Since such a shape has been already shown in the drawings, the corresponding drawing is omitted in order to avoid redundancy.

Korean Patent No. 1,560,365, granted to the inventor of the present invention, discloses a diaphragm structure for securing stiffness enough to sufficiently prevent break-up mode vibrations of a diaphragm having a major axis and a minor axis to improve the sound characteristics. Such a diaphragm has a very high stiffness due to the shape thereof. However, in order to prevent the break-up mode vibration of the diaphragm having a shape with the major axis and the minor axis and to improve the sound quality, techniques other than securing stiffness are further required.

In the case where the diaphragm does not have a point-symmetrical shape (circle, square, etc.), particularly the diaphragm has a thin and long shape (having a major axis and a minor axis), the vibration direction of the diaphragm may be disturbed or shaken, even though high stiffness of the diaphragm may be secured and thus deformation of the diaphragm can be prevented. Particularly, in the case of a compact speaker, this behavior of the diaphragm causes elements around the diaphragm to collide or produce friction with the diaphragm, which results in noise.

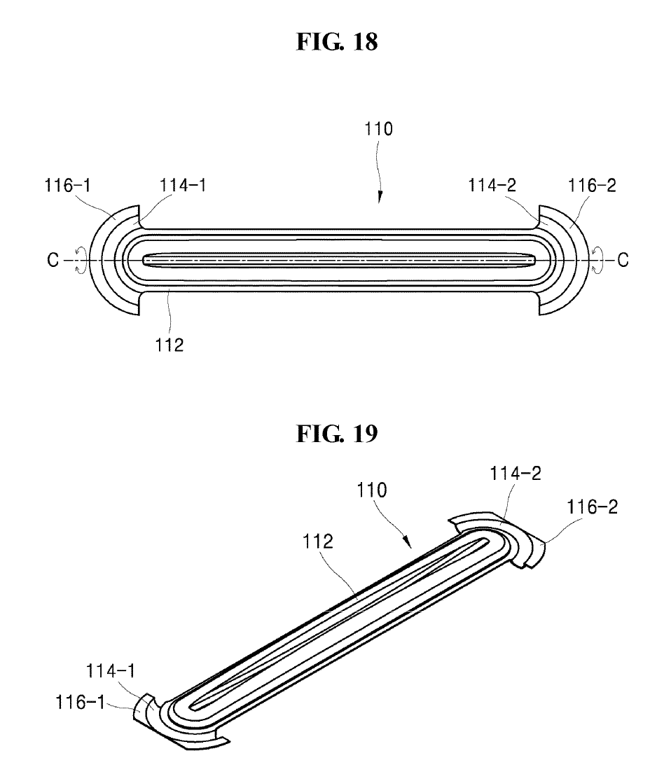

FIGS. 17 and 18 show a diaphragm type obtained by applying the present invention to the structure of the diaphragm disclosed in Korean Patent No. 1,560,365. The illustrated diaphragm 110 has extensions 114-1 and 114-2 extending outward from the rim near both ends of the major axis of the vibration surface 112 and has joining portions 116-1 and 116-2 formed at the ends of the extensions. When both ends of line C-C, which is the major axis of the diaphragm 110, is supported on the frame 200 by the extensions and the joining portions, the diaphragm is likely to roll about line C-C, which is the major axis of the diaphragm 110 and serves as a rotation axis, independently of the damping force provided by the extensions and the joining portions because the diaphragm is axially connected to the frame 200 along line C-C. Such rolling of the diaphragm causes contact between the voice coil 140 fixed to the bottom of the diaphragm assembly 110, 120 and 130 and the magnetic circuits 310, 320 and 330, which may result in undesired noise in the speaker.

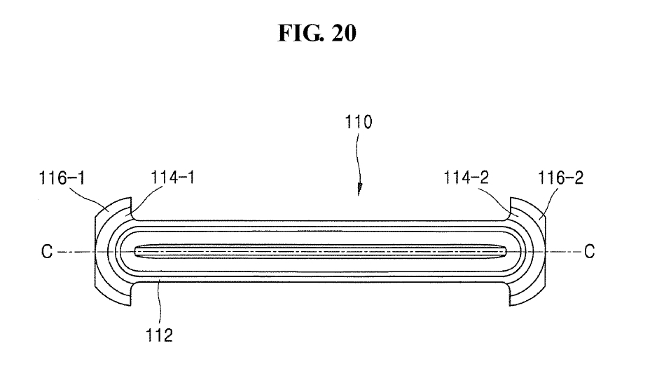

Accordingly, in the present invention, the vibration surface 112 is arranged unconnected with the frame 200 at the portion of the major axis line C-C line that causes such rolling, thereby preventing the diaphragm 110 from rolling about the major axis. To this end, the present invention discloses a structure in which at least a joining portion is eliminated from the part of the major axis line C-C. For example, FIGS. 19 and 20 illustrate a diaphragm in which the joining portion 116 is not formed on the portion of the major axis line C-C. This configuration may be obtained by cutting away parts of the joining portions formed at both ends of the major axis of FIGS. 17 and 18 along a cutting line parallel with the minor axis. As the vibration surface is not directly connected to the frame 200 through the extensions and the joining portions on the major axis, the above-described concern may be eliminated.

The diaphragm shown in FIG. 15 also has a structure in which the major axis is not directly connected to the frame 200. In this structure, none of the extensions and the joining portions is formed on the major axis. The diaphragm shown in FIGS. 13 and 14 also has a structure in which the major axis is not directly connected to the frame 200. In this structure, the extensions are not formed on the major axis.

As described above, when at least one of the extensions and the joining portion proposed in the present invention is configured not to be formed on the major axis at both ends of the major axis of the vibration surface, rolling of the diaphragm described above may be prevented.

It is apparent that the shapes of the extensions and the joining portions described in the embodiments above can be combined with each other. That is, various combinations relating to whether a secondary joining portions is to be formed in addition to the primary extension, what kind of angle (among an acute angle, a right angle, and an obtuse angle) is to be formed between the vibration surface and the extensions, whether or not the joining portion is connected in an annular shape, whether the extension is bent downward or upward, whether the extension has a refracting shape, whether or not at least one of the extensions and the joining portions is eliminated from the major axis portion at both ends of the major axis of the vibration surface, and the like are also within the scope of the present invention.

FIGS. 2 and 3 illustrate a speaker apparatus including a diaphragm assembly according to an embodiment of the present invention. The speaker apparatus includes a diaphragm assembly 110, 120, and 130, a voice coil 140, magnetic circuits 310, 320, and 330, and a frame 200. The voice coil 140 may be attached to the bottom of the diaphragm assembly 110, 120 and 130. The voice coil may be self-bonded and attached to the bottom of the diaphragm assembly 110, 120 and 130, or may be attached to the bottom of the diaphragm assembly with a bobbin interposed therebetween. The voice coil 140 may have a circular shape as shown in FIG. 3, a square shape, or a track shape, depending on the shape of the magnetic circuit. The voice coil 140 may be joined to a seating portion formed on the suspension 130 or to the bottom surface of the diaphragm 110, according to an embodiment.

The magnetic circuit includes a yoke 330, a magnet 320 and a plate 310. In the positional relationship between the magnet 320 and the voice coil 140, the magnet 320 may be positioned outside or inside the voice coil 140, or may be distributed inside and outside the voice coil 140. The magnet 320 may be made of a material such as neodymium or ferrite according to an embodiment.

The frame 200 forms the outer shape of the speaker apparatus, accommodates the magnetic circuits 310, 320 and 330 therein, and is joined to the edge of the diaphragm assembly 110, 120 and 130 through the rim of the upper opening. According to an embodiment, a radiator 400 formed of a material such as a metal having a high thermal conductivity as shown in FIG. 3 may be further provided to improve heat dissipation performance. The radiator 400 is configured to discharge heat generated from the voice coil 140 to the outside. As shown in the figure, the radiator 400 may be configured to be coupled to an opening formed on the bottom surface of the frame 200 including a plurality of heat dissipation holes. Further, it is preferable that the radiator grill is brought into contact with the magnetic circuits 310, 320, and 330 to discharge heat transferred to the magnetic circuits 310, 320, and 330 through conduction.

According to an embodiment, the diaphragm assembly may further include a suspension 130 composed of a metal leaf spring. The suspension 130 may be attached to the bottom surface of the diaphragm assembly to provide additional damping force to the diaphragm. The voice coil 140 may be directly joined to the bottom surface of the suspension, and an end of the voice coil may be connected to the suspension. The suspension may further function as an electric path for providing an external acoustic signal to the voice coil.

The diaphragm 110 of the diaphragm assembly may further include a stiffness enhancing portion for enhancing the stiffness on the upper surface thereof. The stiffness enhancing portion may be a convex portion formed in an annular or track shape along the periphery of the diaphragm. According to an embodiment, in order to further enhance the stiffness, the concave portion may be gradually lowered toward the center along the major axis direction as shown in FIG. 3, and the peak point of the convex portion surrounding the concave portion may become higher toward the center along the major axis. The diaphragm may further include expanded portions at both ends of the central are as shown in FIG. 3 to secure a space where the voice coil 140 is seated. In an embodiment further including the suspension 130, since the expanded portion secures a space for attaching the suspension 130, joining between the suspension 130 and the diaphragm 110 may be reinforced, thereby improving the reliability of the speaker apparatus.

### INDUSTRIAL APPLICABILITY

It is apparent that the above-described invention is industrially applicable.

1. A diaphragm assembly comprising:
a diaphragm configured to generate a sound pressure by vibration; and
an edge of an elastic material, a first side of the edge being joined to the diaphragm and a second side of the edge being joined to a fixed end,
wherein the diaphragm comprises:
a vibration surface configured to generate a sound pressure by vibration and formed in a shape having a major axis and a minor axis, the vibration surface having a rim;
an extension extending outward from at least a part of the rim near both ends of the major axis of the vibration surface and not formed on at least a part of the rim near the minor axis of the vibration surface; and
a joining portion formed at an end of the extension and joined to the fixed end, and
wherein the first side of the edge is joined to the rim of the vibration surface.

2. The diaphragm assembly according to claim 1,
wherein the extension partially extends from the vibration surface.

3. The diaphragm assembly according to claim 2,
wherein the joining portion is annularly connected to connect the plurality of the partially extending extensions.

4. The diaphragm assembly according to claim 2,
wherein the vibration surface is substantially formed in a rectangular shape having the major axis and the minor axis, and
wherein the extension comprises a primary extension formed to extend from both ends of the major axis of the vibration surface.

5. The diaphragm assembly according to claim 4,
wherein the vibration surface further comprises a secondary extension adjacent to the primary extension.

6. The diaphragm assembly according to claim 5,
wherein a surface of the secondary extension adjacent to the primary extension extends at an acute angle with respect to the vibration surface.

7. The diaphragm assembly according to claim 5,
wherein a surface of the secondary extension adjacent to the primary extension extends at an obtuse angle with respect to the vibration surface.

8. The diaphragm assembly according to claim 1,
wherein the extension extends curvedly.

9. The diaphragm assembly according to claim 8,
wherein the extension comprises a downwardly convex shape.

10. The diaphragm assembly according to claim 8,
wherein the vibration surface has the same height as the joining portion.

11. The diaphragm assembly according to claim 8,
wherein the extension comprises an upwardly convex shape.

12. The diaphragm assembly according to claim 11,
wherein a damping agent is applied to an upper surface of the extension.

13. The diaphragm assembly according to claim 1,
wherein the joining portion is joined to a bottom surface of the edge through an upper surface thereof.

14. The diaphragm assembly according to claim 12,
wherein the joining portion is joined to a bottom surface of the edge through an upper surface thereof, and
wherein the damping agent applied to the upper surface of the extension contacts the bottom surface of the edge.

15. The diaphragm assembly according to claim 1,
wherein the joining portion is joined to a frame of a speaker apparatus through a bottom surface thereof.

16. The diaphragm assembly according to claim 1,
wherein the joining portion is joined to a frame of a speaker apparatus with a metal suspension interposed.

17. A diaphragm assembly comprising:
a diaphragm configured to generate a sound pressure by vibration,
wherein the diaphragm comprises:
a vibration surface formed in a shape having a major axis and a minor axis, the vibration surface having a rim;
an extension extending outward from at least a part of the rim near both ends of the major axis of the vibration surface and not formed on at least a part of the rim near the minor axis of the vibration surface; and
a joining portion formed at an end of the extension and joined to the fixed end, wherein a part of the vibration surface on the major axis is not connected to the fixed end.

18. The diaphragm assembly according to claim 17,
wherein at least one of the extension and the joining portion is not formed at the part on the major axis.
